(19) United States
(12) Patent Application Publication
(10) Pub. No.: US 2024/0217771 A1
(43) Pub. Date: Jul. 4, 2024

(54) PLANAR CABLE-WINDING DEVICE

(71) Applicant: DONGGUAN XINUO APOLLO ELECTRICAL TECHNOLOGY CO., LTD., Dongguan City (CN)

(72) Inventor: Senhua Ye, Dongguan City (CN)

(21) Appl. No.: 18/091,326

(22) Filed: Dec. 29, 2022

(51) Int. Cl. B65H 75/40; H01R 13/516; H01R 13/60; H01R 31/02

(52) U.S. Cl. CPC B65H 75/406; H01R 13/516; H01R 13/60; H01R 31/02; B65H 2701/34

(57) ABSTRACT

A planar cable-winding device includes a cable-winding frame. The cable-winding frame includes a left cable-winding segment, a right cable-winding segment, and a connecting arm. The connecting arm has a first rotating shaft hole. A handle is disposed above the connecting arm. The handle has a second rotating shaft hole. A rotating shaft is disposed in the second rotating shaft hole. The rotating shaft extends downward into the first rotating shaft hole. The handle further has a retaining pin and a first retaining hole. The connecting arm further has a second retaining hole. The cable-winding frame further includes a lever and a power socket.

### BACKGROUND OF THE INVENTION

### 1. Field of the Invention

The present invention relates to a cable-winding device, and more particularly to a planar cable-winding device.

### 2. Description of the Prior Art

Cable-winding devices are often used in household power supply, electricity and maintenance testing projects and other occasions. In general, a cable-winding device includes a power module. There are two types of cable-winding devices on the market. One is a three-dimensional cable-winding device, and the other is a planar cable-winding device.

A three-dimensional cable-winding device includes a bracket, a cable-winding reel, and a lever. The rear of the cable-winding reel is provided with a pivot. The cable-winding reel is movably mounted on the bracket through the pivot. The lever is disposed on the pivot. When in use, the bracket is supported on the ground, and the user operates the lever to drive the cable-winding reel to rotate for winding and unwinding a power cable. However, this three-dimensional cable-winding device is big in size, and it is more suitable for large power cable reels. As to a small power cable reel, its height is small. It is troublesome for the user to place the three-dimensional cable-winding device on the ground and bend down to operate the three-dimensional cable-winding device. Besides, it is not convenient to carry the three-dimensional cable-winding device. For a small power cable reel, the three-dimensional cable-winding device occupies much space.

A planar cable-winding device usually includes an H-shaped cable-winding frame. A power cable is wound on the H-shaped cable-winding frame. It is small in size and easy to carry. However, when the power cable is to be wound up, the user holds the frame with one hand and wind the power cable around the frame with the other hand. When the cable is to be unwound, the user unwinds the cable in an opposite direction manually. This operation is more troublesome, time-consuming and labor-intensive.

### SUMMARY OF THE INVENTION

In view of the deficiencies of the prior art, the primary object of the present invention is to provide a planar cable-winding device. On the premise of taking up less space, a power cable can be wound up and unwound quickly. It is easy to operate the planar cable-winding device, having a good experience of use.

In order to achieve the above object, the present invention adopts the following technical solutions:

A planar cable-winding device comprises a cable-winding frame. The cable-winding frame includes a left cable-winding segment, a right cable-winding segment spaced apart and facing away from the left cable-winding segment, and a connecting arm connected between the left cable-winding segment and the right cable-winding segment. The left cable-winding segment has a left cable-winding groove that has a left opening and passes through front and rear sides of the cable-winding frame. The right cable-winding segment has a right cable-winding groove that has a right opening and passes through the front and rear sides of the cable-winding frame. The left cable-winding groove and the right cable-winding groove are arranged symmetrically.

The connecting arm has a first rotating shaft hole. A handle is disposed above the connecting arm. The handle has a second rotating shaft hole. A rotating shaft is disposed in the second rotating shaft hole. The rotating shaft extends downward into the first rotating shaft hole and is rotatable relative to the cable-winding frame about its own axis. The handle further has a retaining pin and a first retaining hole. The connecting arm further has a second retaining hole. The second retaining hole is located beside the first rotating shaft hole. The first retaining hole is located beside the second rotating shaft hole. The retaining pin is pluggable and inserted into the first retaining hole and the second retaining hole in sequence. A lever is disposed on a bottom of the left cable-winding segment or a bottom of the right cable-winding segment.

A power socket is disposed on the cable-winding frame between the left cable-winding segment and the right cable-winding segment. The power socket is located below the connecting arm. The power socket has a power input interface and at least one power output interface that are electrically connected.

Compared with the prior art, the present invention has obvious advantages and beneficial effects. Specifically, as can be seen from the above technical solutions, the present invention includes the handle, the connecting arm, the rotating shaft, the first rotating shaft hole, the second rotating shaft hole, the retaining pin, the first retaining hole, the second retaining hole and the lever. When the power cable is to be wound up, the retaining pin is unplugged, and the user holds the handle with one hand and operates the lever to wind up the power cable with the other hand. After the power cable is wound up, the retaining pin is plugged. The handle is independent from the top of the cable-winding frame, and will not interfere with the left cable-winding groove and the right cable-winding groove. The shape and size of the handle can be designed freely and flexibly, and will not be subject to the design and production of the cable-winding frame. The arrangement of the handle meets the hand-held operation. If the user wants to wind up the power cable manually, the retaining pin is plugged so that the handle and the cable-winding frame cannot rotate relative to each other. When the power cable is to be unwound, the retaining pin is unplugged and one end of the power cable is pulled to be unwound quickly. On the premise of taking up less space, the power cable can be wound up and unwound quickly. It is easy to operate the planar cable-winding device, having a good experience of use.

### BRIEF DESCRIPTION OF THE DRAWINGS

FIG. 1 is a front view according to a first embodiment of the present invention;

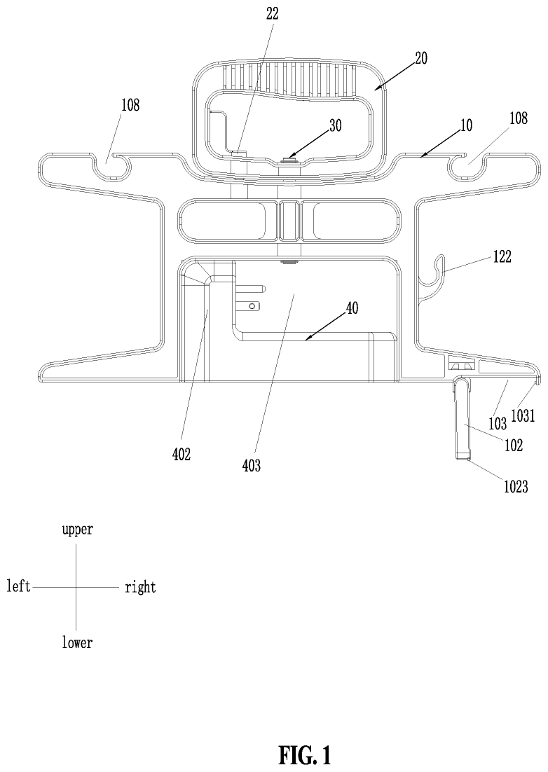

FIG. 2 is an exploded view according to the first embodiment of the present invention;

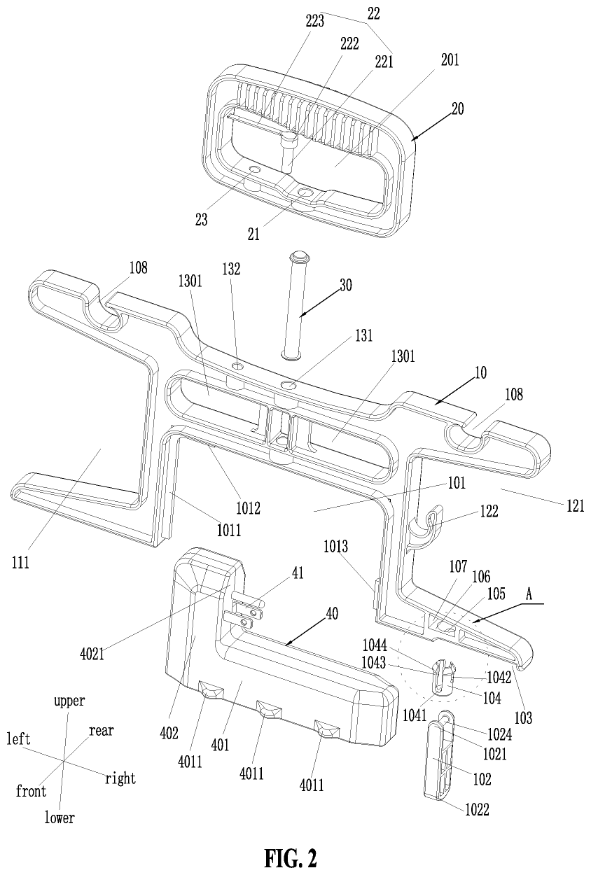

FIG. 3 is another exploded view according to the first embodiment of the present invention;

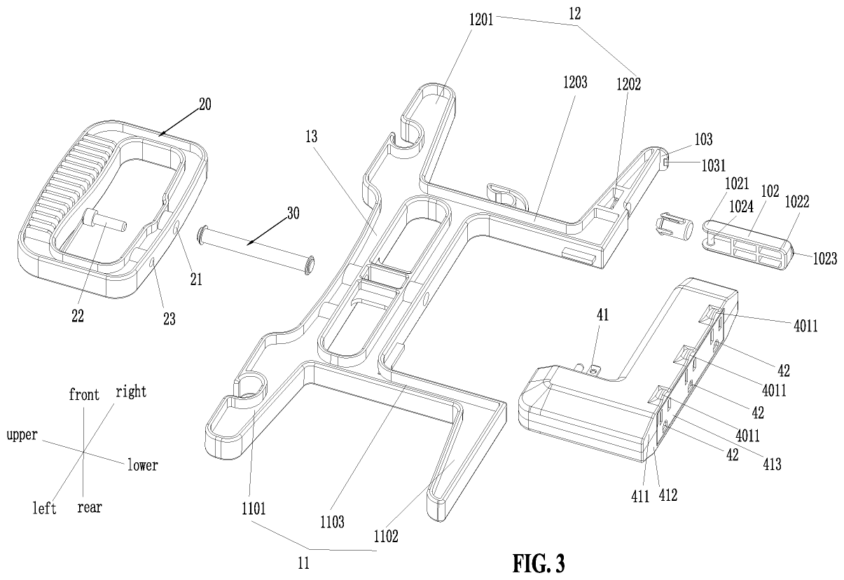

FIG. 4 is a schematic view according to the first embodiment of the present invention when in use, wherein the cable-winding frame is rotatable relative to the handle;

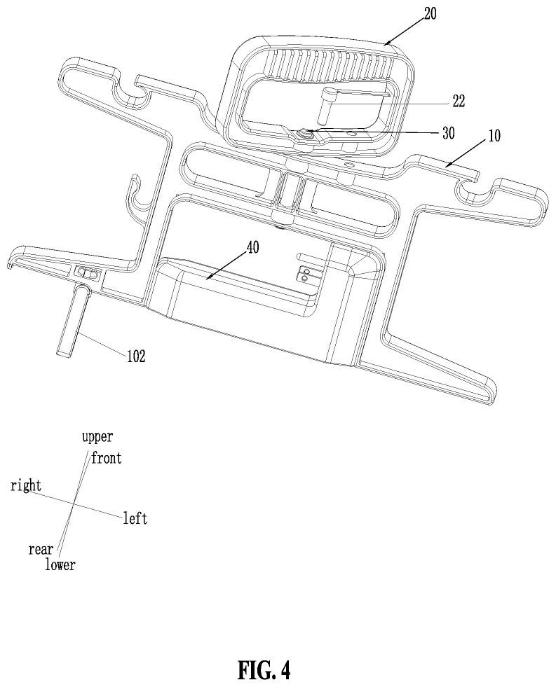

FIG. 5 is an enlarged view of circle A in FIG. 2;

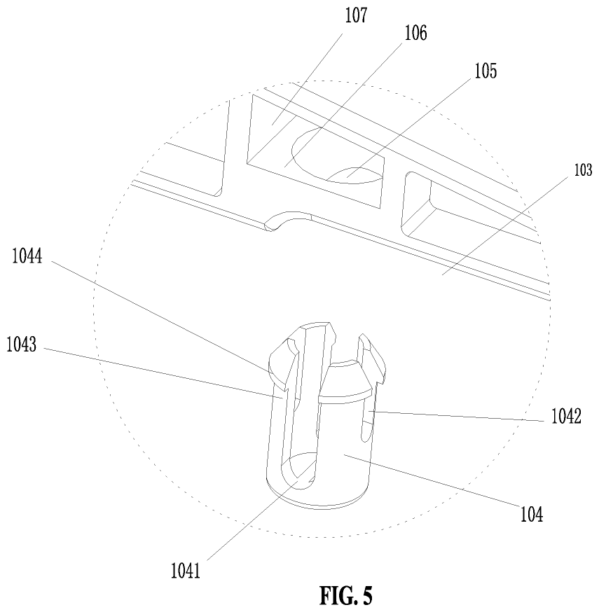

FIG. 6 is a schematic view according to the first embodiment of the present invention, wherein the first power connection port is to be electrically connected to the power input interface;

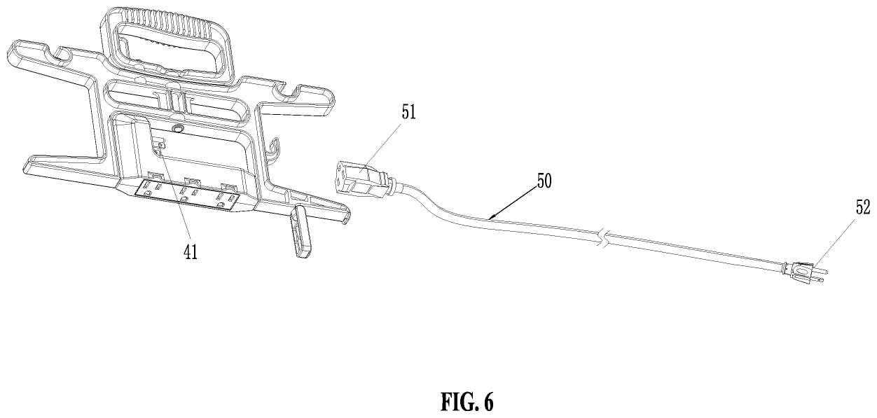

FIG. 7 is a schematic view according to the first embodiment of the present invention, wherein the power cable is wound up on the cable-winding frame;

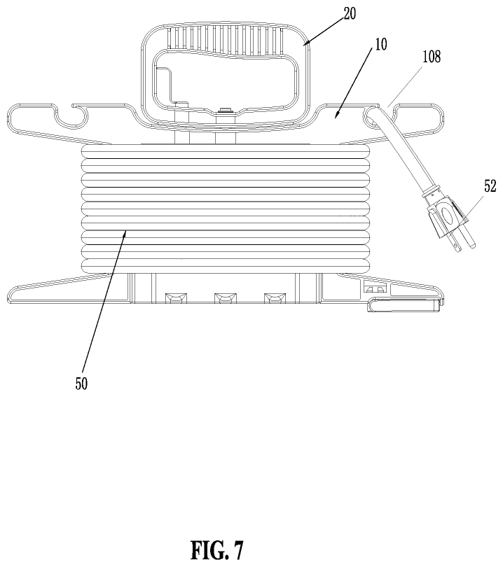

FIG. 8 is a schematic view according to the first embodiment of the present invention, wherein the power cable is first hung on the right J-shaped hook and then wound;

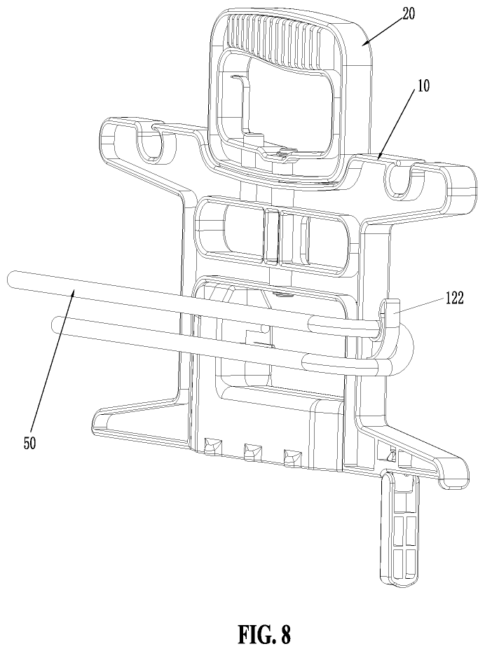

FIG. 9 is another schematic view according to the first embodiment of the present invention, wherein the power cable is wound up on the cable-winding frame; and

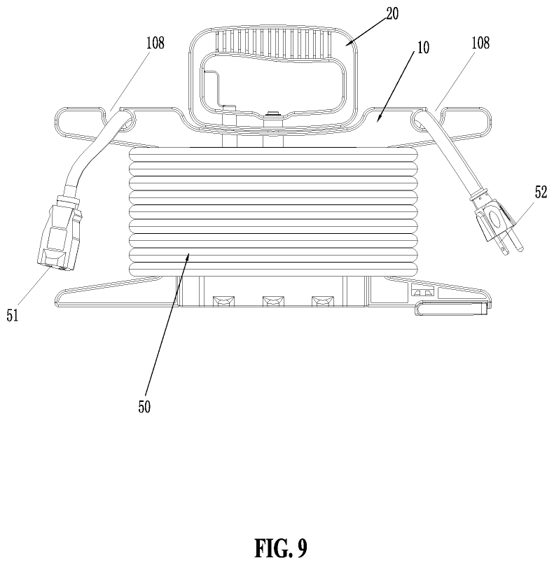

FIG. 10 is a front view according to a second embodiment of the present invention.

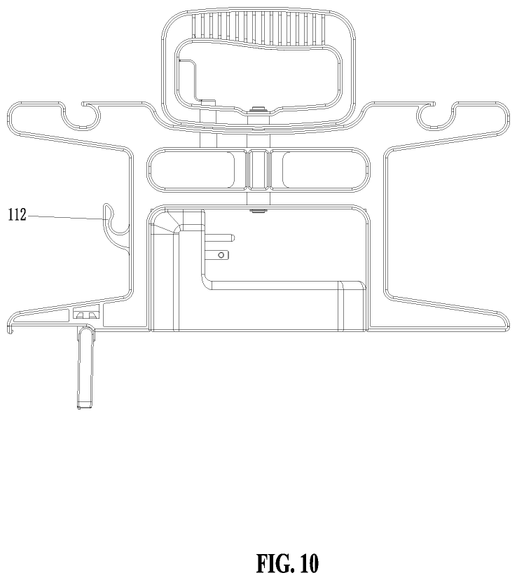

### DETAILED DESCRIPTION OF THE PREFERRED EMBODIMENTS

Embodiments of the present invention will now be described, by way of example only, with reference to the accompanying drawings.

A planar cable-winding device comprises a cable-winding frame 10, a handle 20, a rotating shaft 30, a power socket 40, and a power cable 50.

The cable-winding frame 10 includes a left cable-winding segment 11, a right cable-winding segment 12 spaced apart and facing away from the left cable-winding segment 11, and a connecting arm 13 connected between the left cable-winding segment 11 and the right cable-winding segment 12. The left cable-winding segment 11 has a left cable-winding groove 111 that has a left opening and passes through the front and rear sides of the cable-winding frame 10. The right cable-winding segment 12 has a right cable-winding groove 121 that has a right opening and passes through the front and rear sides of the cable-winding frame 10. The left cable-winding groove 111 and the right cable-winding groove 121 are arranged symmetrically. A mounting groove 101 is disposed between the left cable-winding segment 11 and the right cable-winding segment 12. The mounting groove 101 is located below the connecting arm 13. The mounting groove 101 passes through the bottom and the front and rear sides of the cable-winding frame 10. The left cable-winding segment 11 includes a first left horizontal arm 1101, a second left horizontal arm 1102, and a left vertical arm 1103. The first left horizontal arm 1101 is located above the second left horizontal arm 1102. The upper and lower ends of the left vertical arm 1103 are connected to the right ends of the first left horizontal arm 1101 and the second left horizontal arm 1102, respectively. The left cable-winding groove 111 is surrounded by the first left horizontal arm 1101, the second left horizontal arm 1102 and the left vertical arm 1103. The bottom of the first left horizontal arm 1101 is oblique downward from left to right, and the top of the second left horizontal arm 1102 is oblique upward from left to right, so that the left cable-winding groove 111 is gradually expanded outward from right to left. The right cable-winding segment 12 includes a first right horizontal arm 1201, a second right horizontal arm 1202, and a right vertical arm 1203. The first right horizontal arm 1201 is located above the second right horizontal arm 1202. The upper and lower ends of the right vertical arm 1203 are connected to the left ends of the first right horizontal arm 1201 and the second right horizontal arm 1202, respectively. The right cable-winding groove 121 is surrounded by the first right horizontal arm 1201, the second right horizontal arm 1202 and the right vertical arm 1203. The bottom of the first right horizontal arm 1201 is oblique upward from left to right, and the top of the second right horizontal arm 1202 is oblique downward from left to right, so that the right cable-winding groove 121 is gradually expanded outward from left to right. The left and right cable-winding grooves are gradually expanded outward, which is beneficial for winding up or unwinding a power cable smoothly. The connecting arm 13 has a first rotating shaft hole 131 extending vertically. The connecting arm 13 further has through holes 1301 respectively located at the left and right sides of the first rotating shaft hole 131, thereby reducing load and saving the material. The connecting arm 13 further has a second retaining hole 132. The second retaining hole 132 is located beside the first rotating shaft hole 131.

A lever is disposed on the left cable-winding segment 11 or the right cable-winding segment 12. The lever is a foldable lever 102, which reduces the volume of the product when the lever is not in use and has better portability. A first end 1021 of the foldable lever is hingedly connected to the bottom of the left cable-winding segment 11 or the bottom of the right cable-winding segment 12. The bottom of the left cable-winding segment 11 or the bottom of the right cable-winding segment 12 has a receiving groove 103. A second end 1022 of the foldable lever is movable up and down to be locked in the receiving groove 103. A first buckle 1031 is disposed in the receiving groove 103. A second buckle 1023 is disposed on the second end 1022 of the foldable lever. The second buckle 1023 is locked on the first buckle 1031. A hinge shaft 104 is embedded in the bottom of the left cable-winding segment 11 or the bottom of the right cable-winding segment 12. Specifically, the bottom of the left cable-winding segment 11 or the bottom of the right cable-winding segment 12 is recessed upward to form an engaging groove 105. A stop surface 106 is disposed on the top of the engaging groove 105. The top of the hinge shaft 104 is recessed downward to form a hinge groove 1041. The hinge groove 1041 passes through the front and rear sides of the hinge shaft 104. The top of the hinge shaft 104 is recessed downward to form a deformation groove 1042. The deformation groove 1042 passes through the left and right sides of the hinge shaft 104 and intersects the hinge groove 1041. Neither the hinge groove 1041 nor the deformation groove 1042 passes through the bottom of the hinge shaft 104. The depth of the hinge groove 1041 is greater than the depth of the deformation groove 1042. The top of the hinge shaft 104 is divided into a plurality of elastic pieces 1043 extending downward by the hinge groove 1041 and the deformation groove 1042. The top of the elastic piece 1043 has a barb 1044 protruding toward the outer periphery of the hinge shaft 104. The first end 1021 of the foldable lever has a shaft portion 1024 extending in a front-to-rear direction. The shaft portion 1024 is inserted into the hinge groove 1041 from the top of the hinge shaft 104. The shaft portion 1024 is located below the bottom of the deformation groove 1042. The hinge shaft 104 is inserted upward into the engaging groove 105. Because the shaft portion 1024 is located below the bottom of the deformation groove 1042, in the process of pushing the hinge shaft 104 upward, the elastic pieces 1043 can be deformed inward without being interfered by the hinge shaft 104 until the barb 1044 is engaged on the stop surface 106. In this way, the hinge shaft 104 will not come out downward, so that the first end 1021 of the foldable lever is hingedly connected to the bottom of the left cable-winding segment 11 or the bottom of the right cable-winding segment 12. In this embodiment, the top of the engaging groove 105 is provided with a stop groove 107 passing through the front and rear sides of the cable-winding frame 10. The stop surface 106 is the inner bottom surface of the stop groove 107. The entire cable-winding frame 10 is directly formed by injection molding, which is easy to manufacture.

A left J-shaped hook 112 is provided on the left cable-winding segment 11 corresponding in position to the left cable-winding groove 111, or a right J-shaped hook 122 is provided on the right cable-winding segment 12 corresponding in position to the right cable-winding groove 121. The power cable may be hung on the left J-hook or the right J-hook, so as position the power cable. Thus, the power cable won't be loose. The power cable can be wound tighter, which is beneficial to reduce the volume of the product after the power cable is wound up. Besides, when the power cable is positioned on the hook, it can be wound up with ease. The tops of the left cable-winding segment 11 and the right cable-winding segment 12 each have a positioning groove 108 for positioning the ends of the power cable. The positioning operation is easy by placing the ends of the power cable in the positioning grooves 108.

The handle 20 is located above the connecting arm 13. The handle 20 has a second rotating shaft hole 21 extending vertically. The handle 20 further has a retaining pin 22 and a first retaining hole 23. The first retaining hole 23 is located beside the second rotating shaft hole 21. The retaining pin 22 is integrally formed with the handle 20 by injection molding. The retaining pin 22 has a rod 221, a cap 222 and a bendable piece 223. The cap 222 is integrally connected to the top of the rod 221. One end of the bendable piece 223 is integrally connected to the outer periphery of the cap 222, and the other end of the bendable piece 223 is integrally connected to the left inner wall of a handle hole 201 of the handle 20. The length of the bendable piece 223 is greater than the linear distance between the other end of the bendable piece 223 and the second rotating shaft hole 21. The handle 20 is a flat handle. When the handle 20 and the cable-winding frame 10 cannot rotate relative to each other, the handle 20 and the cable-winding frame 10 are in the same plane. The whole product is planar, takes up less space, and has better portability.

The rotating shaft 30 is located in the second rotating shaft hole 21. The rotating shaft 30 extends downward into the first rotating shaft hole 131 and can rotate relative to the cable-winding frame 10 about its own axis. The retaining pin 22 is pluggable and inserted into the first retaining hole 23 and the second retaining hole 132 in sequence. When the retaining pin 22 is plugged, the cable-winding frame 10 cannot rotate relative to the handle 20. On the contrary, when the retaining pin 22 is unplugged, the cable-winding frame 10 can rotate relative to the handle 20 freely. When the power cable is to be wound up, the retaining pin 22 is plugged so that the cable-winding frame 10 cannot rotate relative to the handle 20, and then the power cable is wound up manually. Alternatively, the retaining pin 22 is unplugged, and the lever 102 is unfolded for winding the power cable with the user's both hands. When the power cable is to be unwound, the retaining pin 22 is unplugged and one end of the power cable 50 is pulled to be unwound quickly.

The power socket 40 is disposed on the cable-winding frame 10 between the left cable-winding segment 11 and the right cable-winding segment 12. The power socket 40 is fixed in the mounting groove 101. The power socket 40 is located below the connecting arm 13. The power socket 40 has a power input interface 41 and at least one power output interface 42 that are electrically connected. The power socket 40 includes a plastic shell. The plastic shell includes an L-shaped front shell 411, an L-shaped rear shell 412 and a bottom shell 413. The L-shaped front shell 411 and the L-shaped rear shell 412 are joined together to form an L-shaped shell. The bottom shell 413 has a plurality of jacks for the at least one power output interface 42 to be arranged correspondingly. The components forming electrical connection between the power input interface 41 and the power output interface 42 are accommodated inside the plastic shell. The power socket 40 includes a horizontal portion 401 and a vertical portion 402 integrally connected to the top of the horizontal portion 401. An operation space 403 is defined between the vertical portion 402 and the left cable-winding segment 11 or between the vertical portion 402 and the right cable-winding segment 12. The power input interface 41 is disposed on one side 4021 of the vertical portion 402, facing the operation space 403. The at least one power output interface 42 is plural and spaced apart from each other along the horizontal portion 401. The front side of the horizontal portion 401 has a raised block 4011. When in use, the external power cable will not be beyond the raised block 4011. The raised block 4011 is configured to protect the cable of the external power cable, close to the plug, and prevent the cable from being damaged. The raised block 4011 is integrally formed with the L-shaped front shell 411. The power socket 40 is mounted in the mounting groove 101 and fixed in the mounting groove 101 by ultrasonic welding. A left rib 1011, a top rib 1012 and a right rib 1013 are provided on the inner wall of the mounting groove 101. The left rib 1011 and the top rib 1012 are mated with the left side and the top of the vertical portion 402. The right rib 1013 is mated with the right side of the horizontal portion 401. The integration of the power socket 40 and the cable-winding frame 10 is good.

A power cable 50 is detachably disposed on the cable-winding frame 10. Both ends of the power cable 50 have a first power connection port 51 and a second power connection port 52, respectively. The first power connection port 51 is detachably, electrically connected to the power input interface 41.

What is claimed is:

1. A planar cable-winding device, comprising a cable-winding frame, the cable-winding frame including a left cable-winding segment, a right cable-winding segment spaced apart and facing away from the left cable-winding segment, and a connecting arm connected between the left cable-winding segment and the right cable-winding segment; the left cable-winding segment having a left cable-winding groove that has a left opening and passes through front and rear sides of the cable-winding frame, the right cable-winding segment having a right cable-winding groove that has a right opening and passes through the front and rear sides of the cable-winding frame, the left cable-winding groove and the right cable-winding groove being arranged symmetrically;
the connecting arm having a first rotating shaft hole, a handle being disposed above the connecting arm, the handle having a second rotating shaft hole, a rotating shaft being disposed in the second rotating shaft hole, the rotating shaft extending downward into the first rotating shaft hole and being rotatable relative to the cable-winding frame about its own axis; the handle further having a retaining pin and a first retaining hole, the connecting arm further having a second retaining hole, the second retaining hole being located beside the first rotating shaft hole, the first retaining hole being located beside the second rotating shaft hole, the retaining pin being pluggable and inserted into the first retaining hole and the second retaining hole in sequence; a lever being disposed on a bottom of the left cable-winding segment or a bottom of the right cable-winding segment;
a power socket being disposed on the cable-winding frame between the left cable-winding segment and the right cable-winding segment, the power socket being located below the connecting arm, the power socket having a power input interface and at least one power output interface that are electrically connected.

2. The planar cable-winding device as claimed in claim 1, wherein the power socket includes a horizontal portion and a vertical portion integrally connected to a top of the horizontal portion, an operation space being defined between the vertical portion and the left cable-winding segment or between the vertical portion and the right cable-winding segment, the power input interface is disposed on one side of the vertical portion, facing the operation space, and the at least one power output interface is plural and spaced apart from each other along the horizontal portion.

3. The planar cable-winding device as claimed in claim 2, wherein a mounting groove is disposed between the left cable-winding segment and the right cable-winding segment, the mounting groove is located below the connecting arm, the mounting groove passes through a bottom and the front and rear sides of the cable-winding frame, and the power socket is fixed in the mounting groove.

4. The planar cable-winding device as claimed in claim 3, wherein the power socket is mounted in the mounting groove and fixed in the mounting groove by ultrasonic welding.

5. The planar cable-winding device as claimed in claim 1, wherein a left J-shaped hook is provided on the left cable-winding segment corresponding in position to the left cable-winding groove.

6. The planar cable-winding device as claimed in claim 1, wherein a right J-shaped hook is provided on the right cable-winding segment corresponding in position to the right cable-winding groove.

7. The planar cable-winding device as claimed in claim 1, wherein the lever is a foldable lever, a first end of the foldable lever is hingedly connected to the bottom of the left cable-winding segment, the bottom of the left cable-winding segment has a receiving groove, and a second end of the foldable lever is movable up and down to be locked in the receiving groove.

8. The planar cable-winding device as claimed in claim 1, wherein the lever is a foldable lever, a first end of the foldable lever is hingedly connected to the bottom of the right cable-winding segment, the bottom of the right cable-winding segment has a receiving groove, and a second end of the foldable lever is movable up and down to be locked in the receiving groove.

9. The planar cable-winding device as claimed in claim 7, wherein a first buckle is disposed in the receiving groove, a second buckle is disposed on the second end of the foldable lever, and the second buckle is locked on the first buckle.

10. The planar cable-winding device as claimed in claim 2, wherein a front side of the horizontal portion has a raised block.

11. The planar cable-winding device as claimed in claim 2, wherein a top of the left cable-winding segment has a positioning groove.

12. The planar cable-winding device as claimed in claim 2, wherein a top of the right cable-winding segment has a positioning groove.

13. The planar cable-winding device as claimed in claim 2, wherein tops of the left cable-winding segment and the right cable-winding segment each have a positioning groove.

14. The planar cable-winding device as claimed in claim 1, wherein the handle is a flat handle.
